(19) United States
(12) Patent Application Publication
(10) Pub. No.: US 2007/0204456 A1
(43) Pub. Date: Sep. 6, 2007

(54) Fastener retention device and method

(76) Inventor: James Allen Hill, Milford, MI (US)

Correspondence Address: BLISS MCGLYNN, P.C., 2075 WEST BIG BEAVER ROAD, SUITE 600, TROY, MI, 48084, US

(21) Appl. No.: 11/449,241

(22) Filed: Jun. 8, 2006

Related U.S. Application Data
(60) Provisional application No. 60/689,073, filed on Jun. 10, 2005.

(51) Int. Cl. B23P 11/00

(52) U.S. Cl. 29/525.01; 29/522.1

(57) ABSTRACT

A fastener retention device and method for retaining a fastener includes a fastener retainer for receiving a fastener and at least one arm extending from the fastener retainer for attachment to a workpiece. The fastener retainer is disposed over an aperture in the workpiece to retain the fastener in a predetermined position within the aperture in the workpiece.

### CROSS-REFERENCE TO RELATED APPLICATION(S)

The present invention claims the priority date of copending U.S. Provisional Patent Application Ser. No. 60/689,073, filed Jun. 10, 2005.

### BACKGROUND OF THE INVENTION

1. Field of Invention

The present invention relates generally to fasteners and, more particularly, to a fastener retention device and method for retaining fasteners.

2. Description of the Related Art

Fasteners are frequently used to join materials such as sheets or panels. Such constructions are commonly used in a wide variety of industries. In one such example, in the automotive industry, a sheet metal panel is provided with an aperture or bore therein having a diameter slightly greater than that of a shank of the fastener. The shank is passed through the bore and is ultimately assembled to a mating fastener such as a nut or the like in order to join the panel to another structural element.

In many such assemblies, it is often desirable to permit automation of the joining process or other desirable benefits that result from temporarily retaining a fastener, such as a bolt, within the bore in a manner that would resist the forces of gravity, shaking, or minor vibration for a given and sometimes extended time period prior to final assembly of the fastener with a mating fastener. As a result, it is desirable to maintain the fastener within proper alignment in the bore in a position and condition whereby it cannot accidentally fall out of the panel or be dislodged as result of gravity or other minor forces acting thereon until final assembly is completed. A number of prior solutions have attempted to address this problem. Each of these respective solutions has presented some significant drawbacks.

A type of known retaining devices involves putting a thermoplastic or similar retention element on a portion of the shank of the fastener that is desired to be temporarily retained. Forming such a retention element on fasteners can be expensive and involves subjecting each of the fasteners to a separate processing step. If it is desired to maintain the fastener in central alignment within an aperture or bore in the sheet material or panel, the retaining element must extend around the entire circumference of the fastener. Since the retaining element must adhere sufficiently to the fastener so as not to fall off and yet permit retention within the bore, it must be adhered relatively strongly to the fastener.

Such devices have therefore often been made of a pliable resin or other material. These retaining elements, however, often remain completely or at least partly on the fastener after final assembly when the fastener is joined with a mating fastener. As such, they undesirably end up at least partly within the joint or in the thread roots of the fastener. Alternatively, if the retaining elements are not adhered strongly enough to the fastener, the process of locating such a fastener within the bore may dislodge the retaining element to the point where retention of the fastener therein is not possible. Additionally, in order for such devices to be retained in a stationery position within an aperture, virtually the entire axial length of the retaining element along the shaft of the fastener must be in contact with the inner surface of the aperture. An aperture in a thin sheet or panel usually does not provide a sufficient surface area to permit such engagement.

Another type of known retaining devices features an upper and lower flange that engages a portion of a panel or sheet to which a fastener is to be joined above and below a bore in the panel that the device is designed to fit.

Although some of these retaining devices have provided adequate retention of the fastener prior to final assembly, they have also introduced problems. This is because these retaining devices not only initially extend into the area of the ultimate joint, but also stay in this area after final assembly of the fastener.

Still another known type of retaining device has focused on providing a flexible retaining device that resides completely in the bore of the workpiece to which the fastener is to be joined. Such retaining devices utilize a plurality of inwardly extending projections to retain the fastener and either a continuous diameter outer wall or series of outwardly extending projections to engage the bore within which it is placed. In such constructions, the frictional engagement between the outer projections or wall of the retaining device and the inner surface of the bore must be significantly greater than the frictional engagement force between the inwardly extending projections and the fastener that is desired to be retained. This is necessary so that the act of inserting the fastener into the retaining device and bore does not dislodge the retaining device from the bore, yet meets with sufficient frictional force to retain the fastener within the inwardly extending projections.

In order to accomplish this result, such retaining devices have featured a rather extended depth in the outwardly extending wall or projections along the longitudinal length of the bore. This is because an extended surface area contact between the outer wall or projections and the inner surface of the bore is necessary to retain the retaining device in place within the bore and prevent it from being dislodged when the fastener is inserted therein. Such retaining devices have generally exhibited a depth of at least one quarter to one half inch. As a result, such retaining devices are wholly insufficient when it is desired to temporarily retain a fastener within a thin workpiece, such as sheet metal or the like. This is because the inner wall of the bore does not have a sufficient length to provide enough surface area engagement between the inner surface thereof and the retaining device to be able to resist the force of the fastener against the inner surface of the retaining device as it is positioned in the bore.

Therefore, it is desirable to provide a retaining device that temporarily retains a fastener in a bore of a workpiece. It is also desirable to provide a retaining device for a fastener that retains a fastener to a thin panel, sheet of metal, or the like. It is further desirable to provide a retaining device for a fastener that is not located in bore of a workpiece. Therefore, there is a need in the art to provide a retaining device that meets at least one of these desires.

### SUMMARY OF THE INVENTION

It is, therefore, one object of the present invention to provide a fastener retention device and method that can be selectively located on a workpiece having a bore that temporarily retains a fastener within the bore but does not interfere with final assembly and does not remain in a joint upon final assembly.

It is another object of the present invention to provide a fastener retention device and method that moves out of the area of the joint when the fastener is mated with another fastener or similar device.

It is a further object of the present invention to provide a fastener retention device and method that is not located within the bore itself.

It is still further an object of the present invention to provide a fastener retention device and method that assists in centering the fastener within the bore both while the fastener is retained and unassembled and during the process of final assembly of the fastener with a mating fastener.

To achieve at least one of the foregoing objects, the present invention is a fastener retention device for retaining a fastener including a fastener retainer for receiving a fastener and at least one arm extending from the fastener retainer for attachment to a workpiece. The fastener retainer is disposed over an aperture in the workpiece to retain the fastener in a predetermined position within the aperture in the workpiece.

Additionally, the present invention is a method for retaining a fastener to a workpiece. The method includes the steps of providing a fastener retention device and attaching the fastener retention device to a workpiece such that the fastener retention device is disposed over an aperture in the workpiece. The method also includes the steps of retaining the fastener with the fastener retention device such that the fastener is in a predetermined position within the aperture in the workpiece.

One advantage of the present invention is that a fastener retention device and method is provided for retaining a fastener on a workpiece. Another advantage of the present invention is that the fastener retention device and method may be applied to a selected location on a workpiece to retain a fastener in a predetermined position within an aperture in the workpiece. Yet another advantage of the present invention is that the fastener retention device and method includes a retention element made of a flexible material and retains a fastener within a bore in the workpiece awaiting final assembly with a mating fastener or similar device but does not interfere with the final assembly and does not remain in the joint upon final assembly. Still another advantage of the present invention is that the fastener retention device and method does not need the retention element positioned within the bore or make contact with the inner surface of the bore in order to retain the fastener therein.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a plan view of a fastener retention device, according to the present invention.

FIG. 2 is a sectional view taken along the line 2-2 of FIG. 1.

FIG. 3 is a fragmentary elevational view of the fastener retention device of FIGS. 1 and 2 illustrated retaining a fastener within a bore in a workpiece.

FIG. 4 is a view similar to FIG. 3 illustrating the fastener retention device as the fastener is driven down towards the workpiece.

FIG. 5 is a view similar to FIG. 3 illustrating the fastener retention device as the fastener is driven further towards the workpiece.

FIG. 6 is a view similar to FIG. 3, illustrating the fastener retention device with the fastener clamped to the workpiece.

FIG. 7 is an elevational view of the fastener retention device of FIG. 1, illustrating temporarily retaining a fastener within an aperture in a workpiece prior to final assembly of the fastener.

FIG. 8 is a view similar to FIG. 7, illustrating the fastener retention device as the fastener is being driven down towards the workpiece.

FIG. 9 is a view similar to FIG. 7, illustrating the fastener retention device as the fastener is driven further towards the workpiece.

FIG. 10 is a view similar to FIG. 7, illustrating the fastener retention device with the fastener clamped to the workpiece.

FIG. 11 is an elevational view of another embodiment, according to the present invention, of the fastener retention device of FIG. 7.

FIG. 11A is a fragmentary elevational view of the fastener retention device of FIG. 11.

FIG. 11B is a fragmentary elevational view of the fastener retention device of FIG. 11 illustrated in operational relationship with a fastener within a bore in a workpiece.

FIG. 11C is a view similar to FIG. 11, illustrating the fastener retention device as the fastener is driven down towards the workpiece.

FIG. 11D is a view similar to FIG. 11, illustrating the fastener retention device with the fastener clamped to the workpiece.

### DESCRIPTION OF THE PREFERRED EMBODIMENT(S)

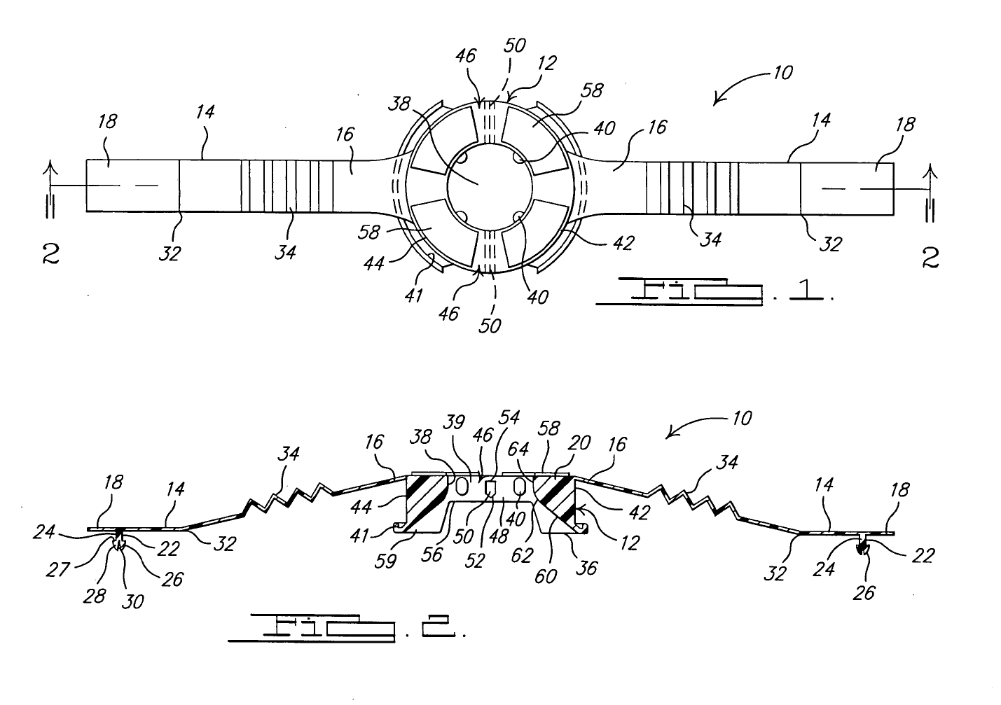

Referring now to the drawings and in particular FIGS. 1 through 11D, certain embodiments of a fastener retention device 10, according to the present invention, are illustrated. It should be appreciated that these embodiments are intended to be exemplary and not limiting. Although the fastener retention device 10 of the present invention is illustrated retaining a fastener such as a bolt, it should be appreciated that it can be utilized with a wide range of other fasteners, including screws and the like to temporarily retain such fasteners in position within an aperture or bore in a workpiece awaiting final assembly. In all embodiments of the present invention, the fastener retention device 10 does not interfere with or become part of the final joint between the fastener and the workpiece to which it is ultimately fastened. Additionally, although the illustrated embodiments of the present invention are described and shown in connection with temporarily retaining a fastener within an aperture such as a bore in a workpiece such as a thin panel or sheet type material such as sheet metal, the present invention can also be utilized to perform the same function in a thicker substrate while retaining the benefits it affords when used in connection with thin sheet material.

Referring particularly to FIGS. 1 and 2, one embodiment of a fastener retention device 10, according to the present invention, is illustrated. The fastener retention device 10 includes a fastener retainer, generally indicated at 12, and at least one, preferably a pair of arms 14 that project outwardly from opposite locations around the circumference of the fastener retainer 12. The arms 14 are generally rectangular in shape and have a generally rectangular cross-sectional shape. Each arm 14 has a proximal end 16 that is connected to the fastener retainer 12 and an opposite distal end 18. Each proximal end 16 is preferably connected at or near a top surface 20 of the fastener retainer 12. It should be appreciated that, although two arms 14 are shown in the embodiment illustrated, a different number of arms could be utilized. It should also be appreciated that, although the arms 14 are illustrated as being generally rectangular in shape and cross-section, they could likewise have other constructions, such as a tapered construction, or a single, circumferential arm that extends around the entire circumference of the fastener retainer 12. It should further be appreciated that, if discreet numbers of separate arms 14 are used, it is preferred that these arms 14 be located approximately 180° across from one another or equally spaced around the fastener retainer 12 in relation to the fastener retainer 12.

The fastener retention device 10 includes at least one attachment mechanism to be attached to a workpiece. In one embodiment, the attachment mechanism is a prong 22 that is integral with and projects from an undersurface of each of the arms 14. Each prong 22 has a small diameter section 24 connected to the arm 14 and a larger diameter section 26 connected to the small diameter section 24 that is spaced from the arm 14. The larger diameter section 26 has a shoulder or flange 27 at one end that connects to the small diameter section 24 and a tapered section 28 at its opposite end. The tapered section 28 includes a central notch 30 that preferably extends through the entire depth of the section 26. It should be appreciated that this construction permits the large diameter section 26 to be press-fit through a bore 72 in a workpiece 66 to be described. It should also be appreciated that, although the prong 22 is illustrated as one embodiment of an attachment mechanism, other attachment mechanisms may be used with the present invention that exhibit a relative ease to attain attachment, a strong resistance to becoming unattached, and a high degree of resiliency.

Each arm 14 is substantially flat near its distal end 18 and is upwardly angled beginning at a distance 32 from the distal end 18 at a substantially continuous angle up to the proximal end 16 thereof to permit the proximal end 16 to join the fastener retainer 12 near the top surface 20 thereof. Between the proximal and distal ends 16 and 18, respectively, of each arm 14, the fastener retention device 10 includes an expansion area 34. In the embodiment illustrated, the expansion area 34 is in the nature of a ridged expansion-type joint. The expansion area 34 allows movement of the fastener retainer 12 as it pivots both axially and downwardly during the process of clamping the fastener and the joint. The expansion area 34 can also be constructed to exhibit a shape memory force to urge the fastener retention device 10 and the fastener retainer 12 back to its original shape and condition once a fastener 74 to be described passes under the top surface 20 of the fastener retention device 10. It should be appreciated that, in another embodiment, the expansion area 34 could be provided in a form other than the one illustrated, as long as the expansion and shape memory characteristics are retained in the construction. It should also be appreciated that together the fastener retainer 12, arms 14, and prongs 22 act as a suspension system to dampen out vibration, minor forces, and the like that may be encountered while the fastener retention device 10 is retaining a fastener and to return the device 10 and fastener to the same centered position when such forces are not present.

The fastener retainer 12 has a bottom surface 36 and a top surface 20 that are generally circular in shape. The fastener retainer 12 also has a circular bore 38 located in a center thereof. As illustrated in FIGS. 1 and 2, an inner wall 39 of the bore 38 includes at least one, preferably a number of projections 40. More or less projections 40 than are illustrated can be utilized depending upon the fastener to be retained. It is preferable that the projections 40 be spaced circumferentially in opposite or equally spaced positions in order to contact and retain a shank of a fastener therein. The projections 40 are illustrated as having a rounded shape. The projections 40 may be optionally provided with a hollow center. The diameter formed by the innermost points of the projections 40 is preferably slightly less than the diameter of a shank of a fastener that is desired to be retained. The diameter of the top surface 20 of the fastener retention device 10 can be greater than or equal to less than the diameter of a head of a fastener to be retained. The bottom surface 36 provides a ridge 41 along a portion of the outer circumference thereof. In one embodiment, the bottom surface 36 and the bottom of the ridge 41 are substantially smooth. It should be appreciated that, in another embodiment, the ridge 41 can be completely horizontal or rounded in contrast to the construction illustrated in FIG. 2. It should also be understood that the projections 40 may be flat, pointed, tapered, or have any other suitable shape.

As illustrated in FIGS. 1 and 2, the fastener retainer 12 includes opposing sidewalls 42 and 44 that extend between the top surface 20 and bottom surface 36 of the fastener retainer 12. The sidewalls 42 and 44 extend circumferentially around only a portion of the entire circumference of the fastener retainer 12. The sidewalls 42 and 44 are provided around a portion of the circumference and in the area where the arms 14 are attached to the fastener retainer 12. The fastener retainer 12 includes at least one expansion area, generally indicated at 46. Spaced circumferentially between the sidewalls 42 and 44 are a pair of expansion areas 46 in the embodiment illustrated. Each expansion area 46 extends downwardly from the top surface 20 of the fastener retainer 12 and is integral with and connected to the sidewalls 42 and 44, respectively, at either end of its circumference. Each expansion area 46 has a wall 48 that extends from the top surface 20 of the fastener retention device 10 downwardly along only a portion of the total depth of the fastener retainer 12.

The expansion area 46 stretches or expands as force is exerted by the fastener 74 against the top surface 20 of the fastener retainer 12 to permit the head of the fastener 74 to move from an initial position above the top surface 20 to one below that surface as downward pressure is exerted on the fastener 74 by mating with another fastener 80 (FIG. 6) or other mechanism. In addition to this construction, it is also preferred that the wall 48 be provided with additional flexibility or expansion capacity when compared to the sidewalls 42 and 44. This can be accomplished in several ways. One such way is to reduce the thickness of the wall 48 compared to the thickness of the sidewall 42,44. Another way to improve this flexibility or expansion is to provide a void 50 located in the expansion area 46 as illustrated in, for example, FIG. 2. A variety of different geometries including a rectangular construction can be utilized for the void 50. In the embodiment illustrated, the void 50 has a pointed bottom 52 and a rectangular top 54. It should be appreciated that such a construction allows a relatively easy tear of a bottom wall 56 below the pointed bottom 52 and a substantially higher resistance to both stretching and tearing as in the area of the top 54 of the void 50 and the area between the void 50 and the top surface 20 of the fastener retainer 12.

The top surface 20 of the fastener retention device 10 can also be provided with optional contact pads 58. These pads 58 preferably have a smooth, substantially flat surface and are slightly raised above the top surface 20. Use of these pads 58 can somewhat reduce the frictional engagement between the edge of the underside of the head 76 of the fastener 74 as the head 76 is moved in a direction toward the aperture 68 in the workpiece 66, since the pads 58 do not extend the entire circumferential area of the top surface 20. It should be appreciated that the pads 58 provide a second potential benefit in that contaminants are limited from depositing themselves thereon once the fastener 74 is positioned against them while the areas between the pads 58 allow moisture and the like to move away from the area of the pads 58.

Each of the sidewalls 42 and 44 have an inner wall 59. The inner wall 59 includes an angled section 60 along all or a substantial portion of their entire circumference that extends upwardly from the bottom surface 36. Although a variety of angles are acceptable, it is preferred that the angles be about forty-five degrees. The angled section 60 is substantially continuous along its entire length. The angled section 60 assists in generating additional force sufficient to tear the expansion area 46 below the void 50 as the sidewalls 42 and 44 pivot and the angled section 60 contacts the workpiece 66 under the downward force of the fastener 74 retained in the fastener retention device 10 during the final assembly process. The inner wall 59 also includes a rounded section 62 that is located above the angled section 60. A portion of the rounded section 62 is preferably in close axial alignment with the bottom wall 56 of the expansion areas 46. The inner wall 59 includes a straight or linear section 64 at the upper portion of the rounded section 62. The bottom of the straight section 64 is located vertically above the bottom wall 56 of the expansion areas 46.

The fastener retention device 10 is preferably constructed of a resilient material such as a plastic, steel, aluminum, or the like. It should be appreciated that the fastener retention device 10 is a monolithic structure being integral, unitary, and one-piece.

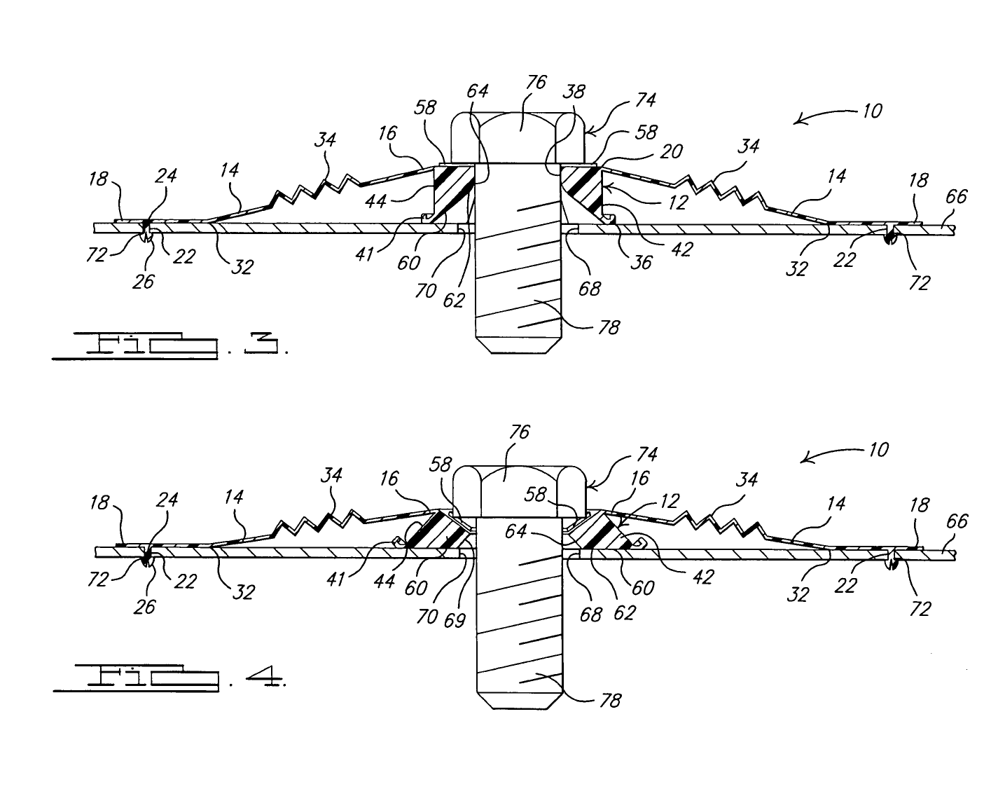

In order to use the fastener retention device 10, it can either first be attached to a workpiece or a fastener. The fastener retention device 10 can be attached to a substrate or workpiece 66 such as a sheet material as illustrated in FIG. 3. The fastener retention device 10 can be used and attached to a variety of different substrates of varying types and thicknesses. A particularly preferred substrate for use with the present invention is a workpiece 66 such as a panel or sheet material with a bore or aperture 68 therein. Such workpieces 66 have a limited depth or thickness. This permits a minimal amount of surface contact along an inner wall 70 of the aperture 68 therethrough. The workpiece 66 also has at least one, preferably a plurality of apertures 72 extending therethrough to receive the prongs 22 of the fastener retention device 10. It should be appreciated that the aperture 68 is designed to accommodate a shank 78 of a fastener 74. It should also be appreciated that, in one embodiment of the prongs 22, at least the portion of the section 26 closest to the flange 27 has a diameter somewhat greater than that of the aperture 72 and that the diameter of the section 24 is slightly less than that of the diameter of the aperture 72. It should further be appreciated that, in one embodiment of the prongs 22, the length of the small diameter section 24 be substantially close to the thickness of the workpiece 66 so that vertical travel of the fastener retention device 10 when it is attached to the workpiece 66 is substantially limited. It should still further be appreciated that, once the fastener 74 is temporarily positioned within the fastener retainer 12 is mated with another fastener 80 (FIG. 6) and no longer retained by the fastener retention device 10, the device 10 may be left in place or removed by cutting the prongs 22, such as by shearing the sections 24 or otherwise to thereby release it.

In another embodiment, the workpiece 66 has a slot (not shown) that does not extend completely can be utilized in lieu of the aperture 72. When the tapered end 28 of the prong 22 is pressed into the aperture 72, the rounded surface thereof encourages it to move more freely through the aperture 72. Likewise, the notch 30 allows the outer surfaces of the section 26 to be pressed toward one another and thereby allows the section 26 to more easily pass through the aperture 72. Once the entire section 26 passes through the aperture 72, compressive force is no longer exerted on the outer surfaces of the section 26. In this position, the notch 30 serves to urge the outer surfaces of the section 26 away from one another as they seek to return. It should be appreciated that the prongs 22 secure the fastener retention device 10 to the workpiece 66 between the undersurface of each arm 14 and the flange 27 of the section 26.

As illustrated in FIGS. 3 through 5 and 7 through 9, downward force on the fastener 74 against the top surface 20 of the fastener retainer 12 causes a downward pivoting of the sidewalls 42 and 44 that, in turn, stretches the expansion areas 46. As this downward force continues, the stretching of the expansion area 46 causes the bottom wall 56 below the void 50 to tear. This, in turn, provides a greater flexibility to the top surface 20 to pivot downwardly and inwardly to permit the fastener 74 to slide downwardly on the top surface 20 of the fastener retainer 12. This allows the portions of the wall 39 on either side of the void 50 to pull an increasing distance apart. The area of the wall 39 above the void 50 still remains intact so that the device 10 will move above the head 76 of the fastener 74 once the head 76 clears the pivoting top surface 20 of the device 10, such as is illustrated in FIGS. 6 and 10. It should be appreciated that, regardless of the construction, in order to permit increased flexibility in the expansion areas 46, these areas can optionally be provided with a greater flexibility than is provided in the arms 14, in order to permit the fastener 74 to move from above the top surface 20 of the device 10 to below that surface.

As previously described, the proximal end 16 of each arm 14 is connected to the fastener retainer 12 near the top surface 20 thereof. The fastener retainer 12 has both a static function and a dynamic function. In its static function, the fastener retainer 12 contacts and temporarily retains a fastener 74 therein, centrally positioning it within the aperture 68 of the workpiece 66. In this position, the fastener 74 is spaced from and forced away from the workpiece 66 by the fastener retention device 10. In its dynamic mode, as the fastener 74 temporarily retained therein is moved toward the workpiece 66 and ultimately joined with a mating fastener 80 against the workpiece 66, the fastener retainer 12 continues part of its centering function. In this mode, the fastener retainer 12 also moves from its original position between the head 76 of the fastener 74 and the workpiece 66 to a second position above the head 76 of the fastener 74, where it does not interfere with the joint between the flange of the fastener 74 and the workpiece 66.

The operation of the fastener retention device 10 will now be described with reference to FIGS. 1 through 10. As previously described, in order to use the fastener retention device 10, it must first either be attached to the workpiece 66 or have the fastener 74 inserted. Attachment is accomplished by press fitting the prongs 22 through the apertures 72 in the workpiece 66 until the flange 27 of each prong 22 bears on one surface of the workpiece 66 and the underside of the arm 14 bears on the opposing side of the workpiece 66. With the fastener retention device 10 in this position, it is now ready to have the fastener 74 inserted therein, if this has not already been accomplished.

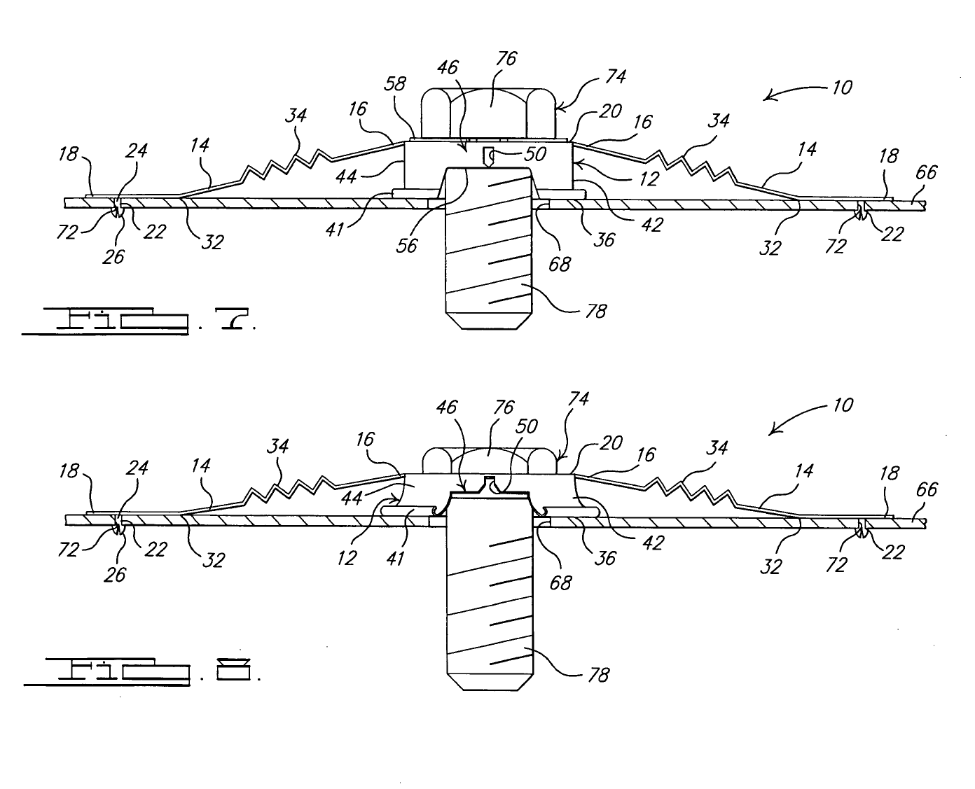

The arms 14 and prongs 22 of the fastener retention device 10 and the apertures 72 in the workpiece 66 are symmetrical and located an equal distance from the center of the fastener retainer 12. The act of attaching the fastener retention device 10 to the workpiece 66 therefore positions the fastener retainer 12 and the aperture 38 therein in a centered position over the aperture 68 in the workpiece 66 through which the shank 78 of the fastener 74 is designed to pass. In this attached position, the bottom surface 36 of the sidewalls 42 and 44 contact the surface of the workpiece 66 as illustrated in FIGS. 3 and 7.

With the fastener retention device 10 attached to the workpiece 66, the fastener retention device 10 is now ready to accept the fastener 74 for the purpose of temporarily retaining it in a centered position within the aperture 68 of the workpiece 66 if this has not been done prior to attachment. As particularly illustrated in FIGS. 3 and 7, the shank 78 of the fastener 74 is passed into the aperture 38 of the fastener retainer 12. As the shank 78 is passed through the aperture 38, it contacts the projections 40. The projections 40 are sized such that they form a diameter slightly smaller than that of the shank 78 and exert an adequate holding force on the shank 78 in order to retain it within the aperture 38 sufficiently to resist forces such as gravity, vibration, and the like until it is desired to finally assemble the fastener 74 to a mating fastener 80 (FIGS. 6 and 10). The retaining force exerted by the projections 40 can be overcome by a downward or axial force exerted thereagainst by the shank 78 of the fastener 74 without tearing the bottom 56 of the expansion area 46 located beneath the void 50.

Once the shank 78 of the fastener 74 is positioned within the projections 40, it is preferred to continue to move the shank 78 therethrough until the undersurface of the head 76 of the fastener 74 is in contact with the contact pads 58 located on the top surface 20 of the fastener retainer 12. In this position, the fastener 74 is retained and centered within the aperture 68 of the workpiece 66 awaiting final assembly and the underside of the head 76 of the fastener 74 is not exposed to contaminants or forces that may tend to dislodge it. The arms 14, prongs 22, and fastener retainer 12 act partially as a suspension system that partially dampens out vibration and like forces while the fastener 74 is located therein. This construction allows the arms 14 to flex thereby permitting a degree of upward movement of the fastener 74 while in the fastener retainer 12. The height of the fastener retainer 12 can be chosen so that the head 76 of the fastener 74 is spaced from the workpiece 66 of a distance that facilitates final assembly of the fastener 74 with a mating fastener or element. Additionally, if the fastener 74 is subjected to a force that has a tendency to move it out of a centered location within the aperture 68, the shape memory and structural characteristics of the fastener retention device 10 recenter the fastener 74 once such force is no longer present.

The operation of the fastener retention device 10 as the fastener 74 is moved from a stationary retention condition therein to final assembly, will now be discussed with reference to FIGS. 4 through 10. In order to bring the fastener 74 into a mating relationship for assembly to another fastener 80, downward and/or rotational forces are exerted on the fastener 74 to bring it in a direction toward the workpiece 66. As a result, the undersurface of the head 76 of the fastener 74 begins to exert a downward force on the contact pads 58 of the top surface 20 of the fastener retainer 12. Such forces cause the sidewalls 42 and 44 to pivot downwardly and inwardly on the bottom surfaces 36 thereof until the angled section 60 of the inner wall 59 is in contact with the workpiece 66 as illustrated in FIG. 4.

This pivoting action likewise exerts a relatively strong axial force on the bottom wall 56 of the expansion areas 46. This force ultimately causes the bottom wall 56 to tear apart and open the bottom of the void 50. This permits the area 46 to expand as the void 50 is now open and can be stretched apart under the same axial force as illustrated in FIG. 8. It should be appreciated that void constructions and geometries other than the void 50 illustrated in the figures can be utilized as long as they exhibit the same functional characteristics under the axial force as the described embodiment.

The pivoting action of the sidewalls 42 and 44 also serves to release the shank 78 of the fastener 74 from contact with the projections 40 since the projections 40 are moved away from contact with the shank 78 as a result of this described movement. The downward force of the fastener 74 against the contact pads 58 also creates an increasing tensioning force in the arms 14, which continue to urge the fastener retainer 12, and particularly the top surface 20 thereof, where it is attached, back to its original position.

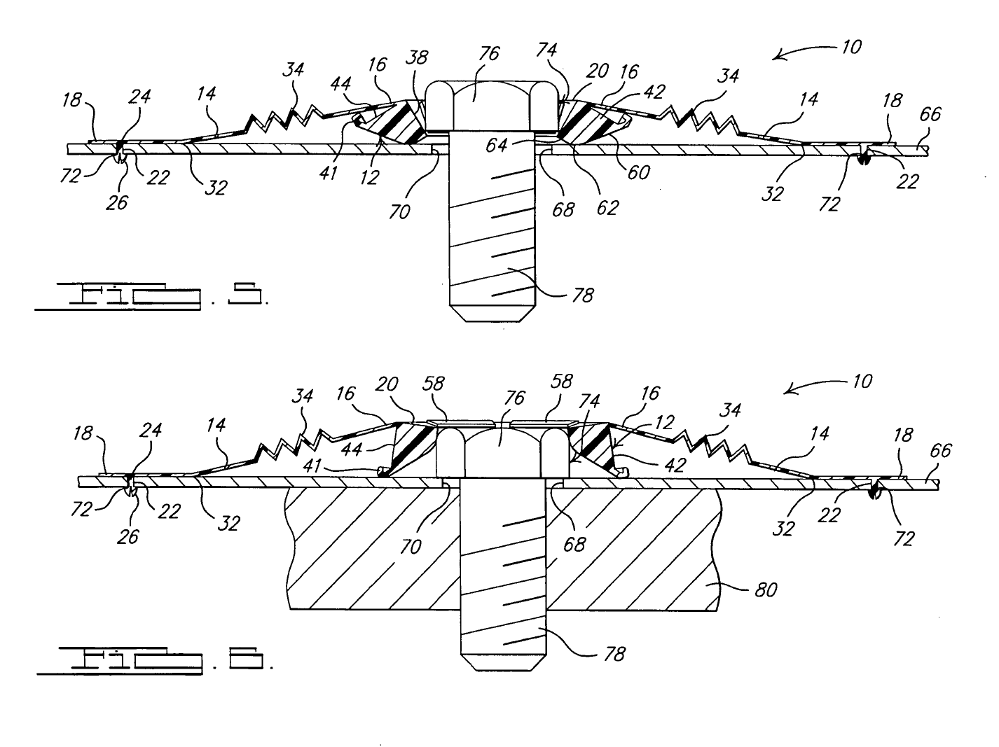

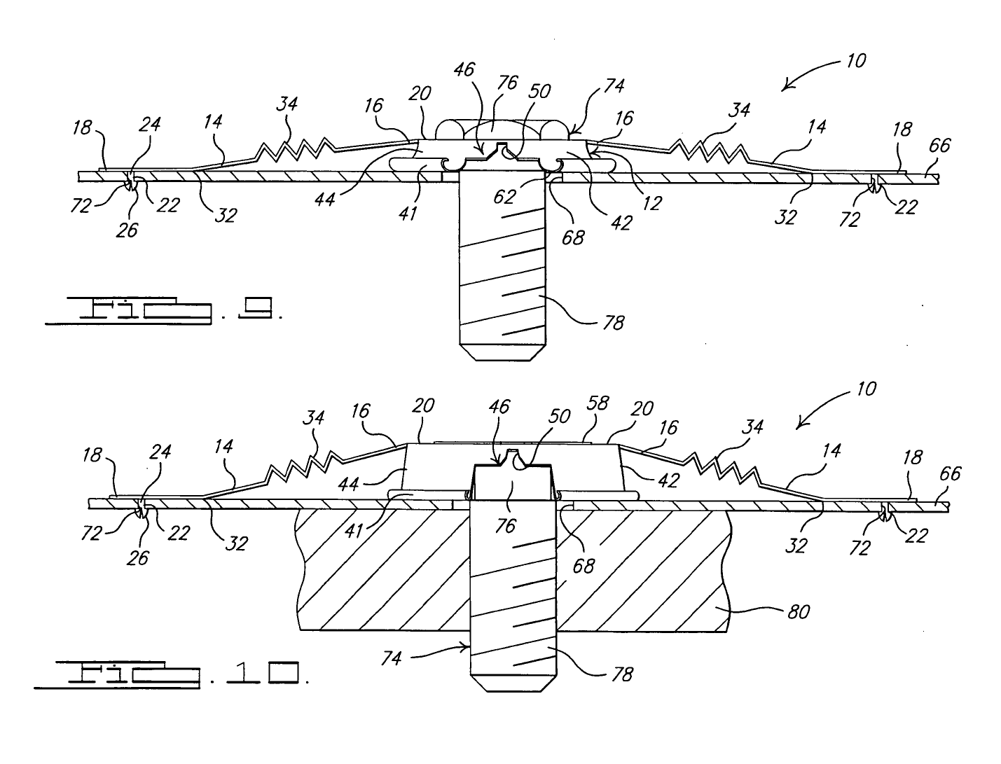

As illustrated in FIGS. 5 and 9, as the fastener 74 is moved closer to the workpiece 66, the downward force exerted on the contacts pads 58 by the undersurface of the head 76 of the fastener 74 tends to further rotate and pivot the sidewalls 42 and 44 until the angled portion 60 of the wall 59 is no longer in contact with the workpiece 66 and the rounded section 62 of the sidewalls 42 and 44 is in contact with the workpiece 66. This contact causes a rolling type movement of the sidewalls 42 and 44 that further pivots them until the straight section 64 of the wall 59 is in contact with the workpiece 66. This results in the contact pads 58 moving to a substantially vertical position until they are no longer under the head 76 of the fastener 74, but are in contact with the sides of the head 76. During this process, the void 50 continues to expand to accommodate the stretching of the expansion area 46 and the axial force that it is under during the continued pivoting of the sidewalls 42 and 44. This likewise increases the tensioning force and upward urging of the arms 14 on the top surface 20 of the fastener retainer 12. It should be appreciated that the geometry of the void 50 provides a greater resistance to axial expansion in the area 46 than in the area 34 thereof.

Once the edge of the top surface 20 of the fastener retainer 12 is moved by the downward force of the head 76 of the fastener 74 to a point where it is no longer under the head 76, the edge of the top surface 20 contacts the smooth side surface of the head 76 and the combination of the tensioning force of the arms 14 and the tensioning force of the expansion areas 46, causes the sidewalls 42 and 44 to pivot upwardly and inwardly to rotate back towards their original position. This motion continues until the bottom surface 36 of the fastener retainer 12 is in contact with the workpiece 66, the straight section 64 of the inner wall 59 is in contact with the upper portion of the head 76 of the fastener 74 and the top surface 20 of the fastener retainer 12 is above the head 76 of the fastener 74. With the fastener retention device 10 in this position, the fastener 74 has moved into its final assembly position with the undersurface of its head 76 in contact with the workpiece 66.

The fastener retention device 10 accomplishes several important objectives as the fastener 74 is moved from its initial retained position to final assembly. During the process of moving the fastener 74 from a retained position within the fastener retention device 10 to a final assembly position, the inner wall 59 of the sidewalls 42 and 44 continues to exert equal and opposing forces on the head 76 of the fastener 74. These forces assist in keeping the shank 76 of the fastener 74 centered within the aperture 68 in the workpiece 66 during the final assembly process. Also, the pivoting action of the sidewalls 42 and 44 that results from the downward force exerted by the fastener 74 on the fastener retainer 12 moves the fastener retainer 12 completely out of the joint area under the surface of the head 76 of the fastener 74 so that it does not interfere and is not located within this joint upon final assembly.

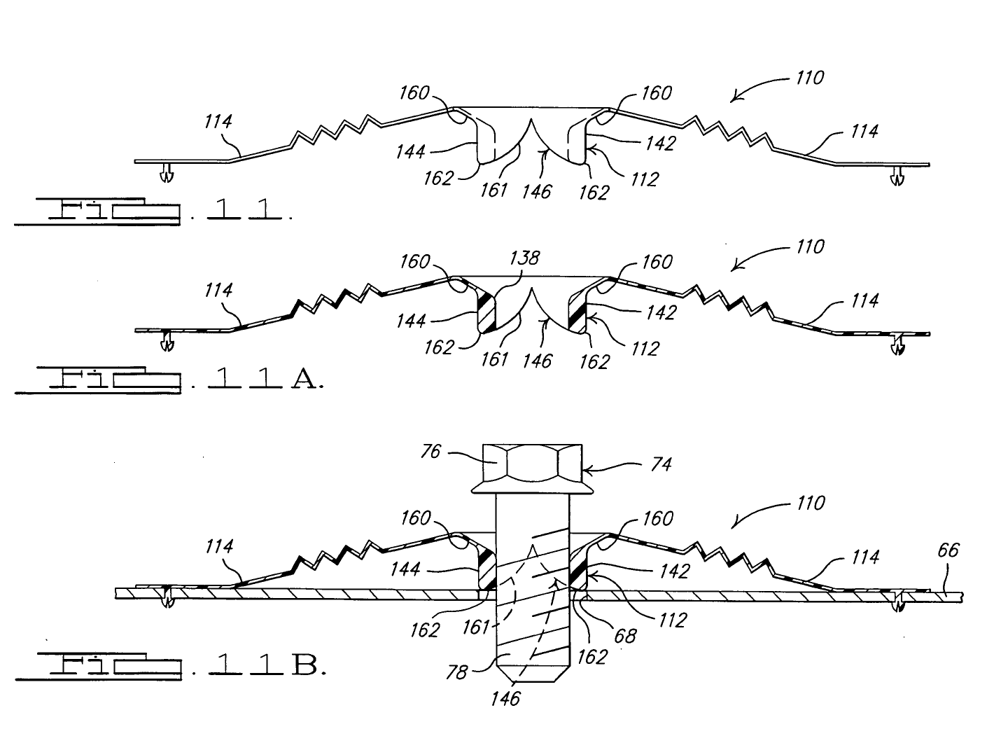

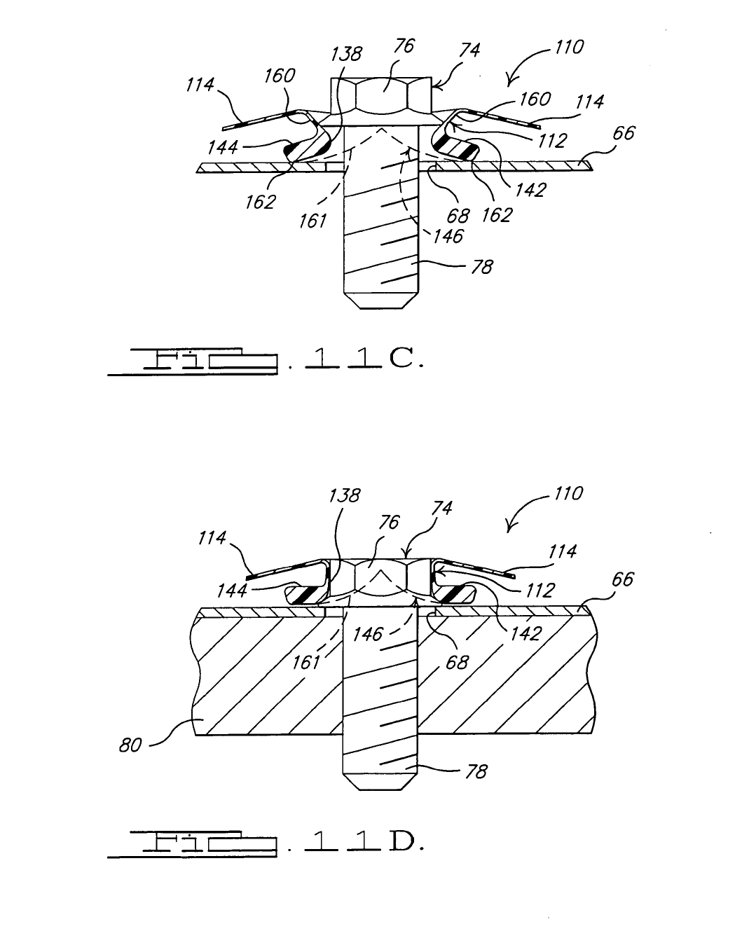

Referring to FIGS. 11 through 11D, another embodiment, according to the present invention, of the fastener retention device 10 is shown. Like parts of the fastener retention device 10 have like reference numerals increased by one hundred (100). In this fastener retention device 110, the retaining device 112 is provided with different features while the remainder of the fastener retention device 110, including the arms 114, is substantially the same as previously described with respect to the fastener retention device 10. In this embodiment, the sidewalls 142 and 144 are again circumferentially spaced with expansion areas 146 located therebetween. These sidewalls 142 and 144 are each provided with a rounded portion 162 at their bottom and an angled portion 160 at their top. The angled portion 160 is substantially constant along its entire length. The expansion areas 146 are provided with an angled notch 161 that is widest at the bottom and narrowest at the top thereof. As downward and/or rotational forces are applied to the fastener 74 to pass it into the aperture 138 of the fastener retainer 112, the sidewalls 142 and 144 are caused to pivot inwardly until they contact opposite sides of the head 76 of the fastener 74 and assist in causing the expansion areas 146 to move from an initial position below the head 76 of the fastener 74 to a position above the head 76 under the downward and rotational forces of the fastener 74.

Referring to FIGS. 11 through 11D, the functioning of the fastener retention device 110 will be described. As the fastener 74 is moved downwardly through the retainer 112, the flange of the fastener 74 contacts the angled portion 160 thereof. This force ultimately causes the sidewalls 142 and 144 to pivot the sidewalls 142 and 144 away from one another out of the path of the flange and increases the opening for the head 76 of the fastener 74 to pass through. As this is occurring, the expansion area 146 is tensioned as are the arms 14, which both urge the fastener retention device 110 back to its original position.

As the downward force on the fastener 74 continues until the flange contacts the workpiece 66 in its final assembly position, the sidewalls 142 and 144 are moved completely out of the way of the flange and are not contained within the joint between the fastener 74 and the workpiece 66. As in the embodiment previously described, the symmetrical nature of the fastener retainer 112 tends to assist in keeping the fastener 74 centered within the aperture 68 of the workpiece 66 during the final assembly process. Both in this embodiment and the previously described embodiment, it is important that the force required to insert the shank 78 of the fastener 74 within the retainers 12 and 112, be less than the force required to axially expand the expansion areas 46 and 146 of the respective embodiments to cause pivoting of the sidewalls 42,44 and 142,144 thereof.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A fastener retention device for retaining a fastener comprising:
a fastener retainer for receiving a fastener;
at least one arm extending from said fastener retainer for attachment to a workpiece; and
wherein said fastener retainer is disposed over an aperture in the workpiece to retain the fastener in a predetermined position within the aperture in the workpiece.

2. A fastener retention device as set forth in claim 1 wherein said fastener retainer includes a pair of opposed sidewalls.

3. A fastener retention device as set forth in claim 2 wherein said fastener retainer includes at least one expansion area therein.

4. A fastener retention device as set forth in claim 3 wherein said at least one expansion area is disposed between said sidewalls.

5. A fastener retention device as set forth in claim 3 wherein said at least one expansion area includes at least one void therein.

6. A fastener retention device as set forth in claim 3 wherein each of said sidewalls include an inner wall having an angled section, a rounded section, and a straight section.

7. A fastener retention device as set forth in claim 1 wherein said fastener retainer includes an aperture extending axially therethrough.

8. A fastener retention device as set forth in claim 7 wherein said fastener retainer includes at least one projection extending radially into said aperture to engage the fastener.

9. A fastener retention device as set forth in claim 1 including at least one contact pad on a top surface of said fastener retainer.

10. A fastener retention device as set forth in claim 1 wherein said at least one arm has a proximal end connected to said fastener retainer and extending to a distal end.

11. A fastener retention device as set forth in claim 10 wherein said at least one arm includes at least one expansion area disposed between said proximal end and said distal end.

12. A fastener retention device as set forth in claim 10 wherein said at least one arm includes an attachment mechanism adapted to attach said at least one arm to the workpiece.

13. A fastener retention device as set forth in claim 12 wherein said attachment mechanism comprises at least one prong extending from said distal end of said at least one arm.

14. A fastener retention device as set forth in claim 1 wherein said fastener retainer and said at least one arm is a monolithic structure being integral, unitary, and one-piece.

15. A fastener retention device for retaining a fastener comprising:
a fastener retainer for receiving a fastener, said fastener retainer including at least one expansion area therein, an aperture extending axially therethrough, and at least one projection extending radially into said aperture to engage the fastener;
at least one arm extending from said fastener retainer, said at least one arm including an attachment mechanism adapted to attach said at least one arm to a workpiece; and
wherein said fastener retainer is disposed over an aperture in the workpiece to retain the fastener in a predetermined position within the aperture in the workpiece.

16. A fastener retention device as set forth in claim 15 wherein said at least one expansion area includes at least one void therein.

17. A fastener retention device as set forth in claim 15 wherein said fastener retainer includes an inner wall having an angled section, a rounded section, and a straight section.

18. A fastener retention device as set forth in claim 15 wherein said fastener retainer includes at least one projection extending radially into said aperture.

19. A fastener retention device as set forth in claim 15 including at least one contact pad on a top surface of said fastener retainer.

20. A fastener retention device for retaining a fastener comprising:
a fastener retainer for receiving a fastener, said fastener retainer comprising a pair of opposed sidewalls, at least one expansion area disposed between said sidewalls, each of said sidewalls including an inner wall having an angled section, a rounded section, and a straight section;
at least one arm extending from said fastener retainer for attachment to a workpiece, said at least one arm including at least one expansion area disposed between said proximal end and said distal end, said at least one arm including an attachment mechanism adapted to attach said at least one arm to the workpiece, said attachment mechanism comprising at least one prong extending from said distal end of said at least one arm; and
wherein said fastener retainer is disposed over an aperture in the workpiece to retain the fastener in a predetermined position within the aperture in the workpiece.

21. A method for retaining a fastener to a workpiece, said method comprising the steps of:
providing a fastener retention device;
attaching the fastener retention device to a workpiece such that the fastener retention device is disposed over an aperture in the workpiece; and
retaining the fastener with the fastener retention device such that the fastener is in a predetermined position within the aperture in the workpiece.

22. A method as set forth in claim 21 including the step of attaching the fastener to the fastener retention device prior to said step of attaching.

23. A method as set forth in claim 21 wherein said step of providing comprises providing a fastener retention device having a fastener retainer for receiving a fastener and at least one arm extending from the fastener retainer for attachment to the workpiece.

24. A method as set forth in claim 23 including the step of inserting the fastener into an aperture of the fastener retainer.

25. A method as set forth in claim 24 including the step of moving the fastener toward the workpiece.

26. A method as set forth in claim 25 including the step of expanding the fastener retainer as the fastener is moved toward the workpiece.

27. A method as set forth in claim 26 including the step of moving a head of the fastener past the fastener retainer.

28. A method as set forth in claim 27 including the step of returning the fastener retainer to its original position after moving the head of the fastener past the fastener retainer.

29. A method as set forth in claim 23 wherein said step of attaching comprising attaching the at least one arm to the workpiece with an attachment mechanism on the at least one arm.

30. A method as set forth in claim 29 wherein said step of attaching the at least one arm comprises providing an attachment mechanism comprising a prong on the at least one arm and inserting the prong through an aperture in the workpiece.
